(19) United States
(12) Patent Application Publication
(10) Pub. No.: US 2024/0375105 A1
(43) Pub. Date: Nov. 14, 2024

(54) DEVICE FOR SEPARATING TARGET OBJECT WITH IMPROVED QUALITY CONTROL AND MANUFACTURING METHOD THEREOF

(71) Applicant: CURIOSIS INC., Seoul (KR)

(72) Inventors: Hoyoung YUN, Seoul (KR); Taehwan SHIN, Seoul (KR); Yujin LEE, Seoul (KR); Sunggyu SHIN, Seoul (KR); Daesung HUR, Seoul (KR); Zhengzhi JIN, Seoul (KR); Seunghye OH, Seoul (KR)

(73) Assignee: CURIOSIS INC., Seoul (KR)

(21) Appl. No.: 18/735,316

(22) Filed: Jun. 6, 2024

Related U.S. Application Data
(63) Continuation of application No. PCT/KR2024/006198, filed on May 8, 2024.

(30) Foreign Application Priority Data
May 9, 2023 (KR) 10-2023-0059531
May 7, 2024 (KR) 10-2024-0060146

(51) Int. Cl. B01L 3/00

(52) U.S. Cl. CPC B01L 3/502761; B01L 3/502707; B01L 2200/0647; B01L 2200/12; B01L 2200/143

(57) ABSTRACT

One embodiment of the present disclosure provides a target object separation device including: an injection part into which a fluid containing microparticles is injected; a first passage part that includes one or more first structures and in which a target object flows with being concentrated in a certain direction while the fluid injected into the injection part flows; a second passage part that is separately formed from the first passage part; and a target object acquisition part that acquires the target object concentrated in the certain direction, wherein the second passage part has the same height as the first passage part and includes one or more second structures formed at the same height as each of the one or more first structures.

### CROSS-REFERENCE TO RELATED APPLICATIONS

This application is a continuation of International Application No. PCT/KR2024/006198 filed on May 8, 2024, which claims priority to Korean Patent Application No. 10-2023-0059531 filed on May 9, 2023 and Korean Patent Application No. 10-2024-0060146 filed on May 7, 2024, the entire contents of which are herein incorporated by reference.

### TECHNICAL FIELD

The present disclosure relates to a device for separating a target object with improved quality control (“QC”) and a method for manufacturing the same, and more particularly, a device and method for separating a target object capable of performing improved QC during a manufacturing process.

### BACKGROUND ART

A sample pretreatment technique that separates and concentrates microparticles such as cells or plasma plays a very important role in various fields such as biological research, in vitro diagnosis, treatment, pharmaceutical, etc. To separate and concentrate these specific microparticles or plasma, a centrifuge is mainly used to separate and concentrate microparticles or plasma based on density differences between cells. However, although the centrifuge is useful when processing a large amount of samples, it has a limitation in processing a small amount of samples with high efficiency, is an expensive tool, and also is in danger of physically damaging microparticles or plasma.

Accordingly, recently, a technology of separating and concentrating microparticles or plasma based on a microfluidic chip is being developed. This is a technology of separating and concentrating microparticles or plasma by installing an arbitrary structure capable of controlling a flow within a channel of several tens of micrometers to several millimeters. The microfluidic chip-based microparticle or plasma separation and concentration technology has advantages of enabling separation and concentration with fewer reagents and less power, providing high portability, and allowing rapid analysis and detection at a lower cost.

The microfluidic chip may include a passage part through which a fluid is separated and micro-patterns. In the microfluidic chip, if the heights of the passage part and the micro-patterns are not constant, the separation effect is drastically reduced, so it is important to keep the heights of the passage part and the micro-patterns constant. However, existing microfluidic chips do not have a structure to ensure whether the heights of the passage part and micro-patterns are consistent. Therefore, researches are needed to solve this problem.

### PRIOR ART DOCUMENT

### Patent Document

Korean Patent Laid-open Publication No. 2011-0005963 (Publication date: Jan. 20, 2011).

### SUMMARY

### Technical Problem

One embodiment of the present disclosure is to provide a target object separation device with improved quality control (QC) that performs a separation and concentration function of an excellent target object, and a method for manufacturing the same.

Also, one embodiment of the present disclosure is to provide a quality control (QC) method of a target object separation device.

### Technical Solution

One embodiment of the present disclosure is to provide a target object separation device with improved QC, a method for manufacturing the target object separation device, and a QC method of the target object separation device.

One embodiment of the present disclosure provides a target object separation device including: an injection part into which a fluid containing microparticles is injected; a first passage part that includes one or more first structures and in which a target object flows with being concentrated in a certain direction while the fluid injected into the injection part flows; a second passage part that is separately formed from the first passage part; and a target object acquisition part that acquires a target object concentrated in the certain direction, wherein the second passage part has the same height as the first passage part, and includes one or more second structures formed at the same height as each of the one or more first structures.

In one embodiment, the second passage part may be formed to confirm whether the first passage part is formed at a certain height.

In one embodiment, the second passage part may include a first zone and a second zone. The second structure disposed in the first zone may have the same height as the first structure disposed in a zone on the first passage part corresponding to the first zone, and the second structure disposed in the second zone may have the same height as the first structure disposed in a zone on the first passage part corresponding to the second zone.

In one embodiment, the second passage part may include a plurality of zones, identifier structures for the plurality of zones may be disposed in the plurality of zones, respectively, and the second structure and the identifier structure disposed in each of the plurality of zones may have the same height as the first structure located on a zone of the first passage part corresponding to each of the plurality of zones.

In one embodiment, a blocking wall may be formed between the first passage part and the second passage part.

In one embodiment, the second passage part may be a passage part in which a quality control (QC) solution is filled, and the QC solution may be cured after being filled in the second passage part to improve bonding strength of the target object separation device.

In one embodiment, the QC solution may contain a host material, which has one or more vinyl groups and is in a liquid state, an initiator soluble in the host material, and a dye soluble in the host material.

In one embodiment, the first passage part may include a plurality of engraved structures that are formed in a groove shape in a direction perpendicular to a main flow direction of the fluid.

In one embodiment, at least one of the injection part, the first passage part, and the target object acquisition part may include a pillar structure disposed in an area except for the plurality of engraved structures.

In one embodiment, the target object separation device may further include a high-speed channel portion that extends in at least a portion of an area between the injection part and the target object acquisition part.

In one embodiment, the target object separation device may further include a non-target object discharge part.

In one embodiment, the target object may be concentrated in a certain direction due to a secondary flow, which is generated by the plurality of engraved structures in a direction perpendicular to the main flow direction of the fluid.

In one embodiment, the plurality of engraved structures may not be disposed in the high-speed channel portion. For example, the plurality of engraved structures may be disposed in a passage part except for the high-speed channel portion.

In one embodiment, the high-speed channel portion may be formed as a ditch-shaped channel along a depth direction in one side of the passage part corresponding to a direction in which the microparticles are concentrated.

In one embodiment, the high-speed channel portion may have a width of 0.1% to 50% of a width of the passage part.

In one embodiment, a micropattern formed by the plurality of engraved structures may have a curved shape.

In one embodiment, the plurality of engraved structures may be disposed in a bottom surface or a ceiling surface of the target object separation device and the plurality of engraved structures may be formed to be disconnected from each other.

In one embodiment, the plurality of engraved structures may form a micropattern in a linear shape, and the linear micropattern may have an angle of 45 degrees to 135 degrees with respect to the main flow direction of the fluid.

In one embodiment, the plurality of engraved structures may form a micropattern having a curved shape from a first point of a starting point to a second point of an end point. A tangent line of the first point may have an angel of 45 degrees to 135 degrees with respect to the main flow direction of the fluid, and a tangent line of the second point may have an angle of 0 degrees to 75 degrees or 105 degrees to 180 degrees with respect to the main flow direction of the fluid.

One embodiment of the present disclosure is to provide a method for manufacturing a target object separation device. The method for manufacturing the target object separation device may include: forming one or more first structures and one or more second structures on a base substrate; forming a pillar and a blocking wall of the target object separation device on the base substrate; and coupling a cover to top of the pillar and the blocking wall, wherein the blocking wall may be a wall between a first passage part and a second passage part, the first passage part may be a passage part in which a target object flows with being concentrated in a certain direction while a fluid injected into an injection part flows, the second passage part may be a passage part in which a quality control (QC) solution is filled and which is formed separately from the first passage part, and each of the one or more first structures may have the same height as the corresponding second structure.

In one embodiment, the second passage part may be formed to confirm whether the first passage part is formed at a certain height.

In one embodiment, the second passage part may include a first zone and a second zone. The second structure disposed in the first zone may have the same height as the first structure disposed in a zone on the first passage part corresponding to the first zone, and the second structure disposed in the second zone may have the same height as the first structure disposed in a zone on the first passage part corresponding to the second zone.

In one embodiment, the second passage part may include a plurality of zones, and the method for manufacturing the target object separation device may further include forming identifier structures for the plurality of zones in the plurality of zones, respectively. The second structure and the identifier structure disposed in each of the plurality of zones may have the same height as the first structure located on a zone of the first passage part corresponding to each of the plurality of zones.

In one embodiment, the second passage part may be a passage part in which a quality control (QC) solution is filled, and the QC solution may be cured after being filled in the second passage part to improve bonding strength of the target object separation device.

In one embodiment, the QC solution may contain a host material, which has one or more vinyl groups and is in a liquid state, an initiator soluble in the host material, and a dye soluble in the host material.

In one embodiment, the fluid may be injected through a syringe connected to the injection port.

In one embodiment, the syringe may be provided with a plastic syringe tip.

One embodiment of the present disclosure is to provide a quality control (QC) method of a target object separation device, including: injecting a QC solution into a second passage part of the target object separation device; identifying a height of the QC solution in the second passage part; and identifying that the target object separation device is defective when the height of the QC solution does not meet a predetermined range reference, wherein the target object separation device may include an injection part into which a fluid containing microparticles is injected, a first passage part in which a target object flows with being concentrated in a certain direction while the fluid injected into the injection part flows, a second passage part that is separately formed from the first passage part, and a target object acquisition part that acquires the target object concentrated in the certain direction.

In one embodiment, the QC method of the target object separation device may further include curing the QC solution injected into the second passage part. The first passage part may include one or more first structures, and the second passage part may have the same height as the first passage part and include one or more second structures formed at the same height as each of the one or more first structures.

In one embodiment, the identifying the height of the QC solution in the second passage part may include identifying at least one of a height of the second passage part, a height of the second structure, and a height difference between the second passage part and the second structure, and the identifying that the target object separation device is defective may include identifying that the target object separation device is defective when at least one of the height of the second passage part, the height of the second structure, and the height difference between the second passage part and the second structure does not meet a predetermined range reference.

In one embodiment, the identifying the height of the QC solution in the second passage part may include identifying the height of the QC solution by irradiating light to the QC solution.

### Advantageous Effects

According to one embodiment of the present disclosure, a defective target object separation device can be identified.

In addition, according to one embodiment of the present disclosure, bonding strength of a target object separation device can be strengthened.

### DESCRIPTION OF DRAWINGS

FIG. 1 is a diagram partially illustrating a target object separation device including a first passage part and a second passage part according to one embodiment of the present disclosure.

FIG. 2 is a diagram illustrating a portion of a second passage part according to one embodiment of the present disclosure.

FIG. 3 is a diagram illustrating a portion of a second passage part including an identifier structure according to one embodiment of the present disclosure.

FIG. 4 is a diagram schematically illustrating the configuration of a target object separation device according to one embodiment of the present disclosure.

FIG. 5A is an enlarged view of a portion of the target object separation device of FIG. 4.

FIG. 5B is a schematic cross-sectional view of a target object separation device including a pillar structure according to one embodiment of the present disclosure.

FIG. 6 is a diagram illustrating a method of manufacturing a target object separation device according to one embodiment of the present disclosure.

FIG. 7 is a diagram illustrating a method of confirming the height of a passage part according to one embodiment of the present disclosure.

FIG. 8 is a diagram illustrating a process of curing a quality control (QC) solution according to one embodiment of the present disclosure.

FIG. 9 is a diagram illustrating a plastic syringe tip for extracting a fluid without a generation of microbubbles according to embodiment of the present disclosure.

### DETAILED DESCRIPTION

To clarify the technical idea of the present disclosure, embodiments of the disclosure will be described in detail with reference to the accompanying drawings. In describing the present disclosure, if it is determined that a detailed description of a known function or component may unnecessarily obscure the gist of the present disclosure, the detailed description will be omitted. In the drawings, components with substantially the same functional configuration are given the same reference numerals and symbols, even if they are shown in different drawings. For convenience of explanation, if necessary, the device and method will be described together. Each operation of the present disclosure does not necessarily have to be performed in the order described, and may be performed in parallel, selectively, or individually.

Terms used in the embodiments of the present disclosure may be selected from general terms that are currently widely used while considering functions of the present disclosure, but may vary depending on the intention or precedents of engineers working in the field, the emergence of new technologies, etc. In addition, in a certain case, there are terms arbitrarily selected by the applicant, and in this case, the meaning will be described in detail in the description of a relevant embodiment. Therefore, the term used in this specification should be defined based on the meaning of the term and the overall content of the present disclosure, rather than simply the name of the term.

A singular representation used herein may include a plural representation unless it represents a definitely different meaning from the context. Terms such as “include” or “have” are used herein and should be understood that they are intended to indicate an existence of several features, numbers, steps, operations, components, parts, or combinations thereof, and should also be understood that greater or fewer features, numbers, steps, operations, components, parts, or combinations thereof may likewise be utilized. That is, throughout the present disclosure, when a part “includes” a component, it means that other components may be further included, rather than excluding the other components, unless otherwise specified.

An expression such as “at least one” modifies an entire list of components, and do not modify the components of the list individually. For example, “at least one of A, B, and C” and “at least one of A, B, or C” means only A, only B, only C, both A and B, both B and C, both A and C, all of A, B, and C, or a combination thereof.

In addition, the terms such as “ . . . part” and “ . . . module” described in the present disclosure refer to a unit that processes at least one function or operation, and this may be implemented as hardware or software, or as a combination of hardware and software.

Throughout this disclosure, when a part is said to be “connected” to another part, it includes not only cases where they are “directly connected,” but also cases where they are “electrically connected” with another element interposed therebetween. Furthermore, when a part “includes” a component, it means that other components may be further included, rather than excluding the other components, unless otherwise specified.

The expression “configured (or set) to” used throughout the present disclosure may be replaced with, depending on situations, for example, “suitable for,” “having the capacity to,” “designed to,” “adapted to,” “made to,” or “capable of.” The term “configured (or set) to” may not necessarily mean “specifically designed to” in hardware. Instead, in some contexts, the expression “system configured to” may mean that the system is “capable of” operating together with other devices or components. For example, the phrase “processor configured (or set) to perform A, B, and C” refers to a dedicated processor (e.g., an embedded processor) to perform those operations or a general-purpose processor (e.g. CPU or application processor) that can perform the operations by executing one or more software programs stored in a memory.

The term “about” used in the present disclosure means within 10% of a given value or range, preferably, within 5%, more preferably, within 1%.

One embodiment of the present disclosure is to provide a target object separation device for separating and/or concentrating specific microparticles such as cells or the like or plasma in a desired direction, and a method for manufacturing the same, namely, a target object separation device with improved QC, and a method for manufacturing the same.

The term “target object” or “target subject” used herein refers to an object or subject, for example, microparticles, plasma, etc. to be separated through a target object separation device. Here, the microparticles may include red blood cells, platelets, white blood cells, circulating tumor cells, stem cells, effete stored erythrocytes, T-cells derived from autologous T-cell expansion, organic microparticles, inorganic microparticles, organometallic microparticles, metallic microparticles, aerosol particles, bacteria, yeast, fungi, algae, viruses, microinvertebrates or their eggs, pollen, cell or tissue fragments, cell masses, cell debris (e.g. cell debris associated with DNA or RNA purification), bioreactor-produced cells or granules, proteins, protein aggregates, prions, vesicles, liposomes, precipitates (e.g., precipitates from blood or blood fractions, industrial process precipitates, wastewater precipitates, etc.), gradules or cells from fermented foods (e.g., gradules or cells from fermented beverages), macromolecules, macromolecular aggregates, DNA, cell organelles, spores, bubbles, droplets, exosomes, and the like.

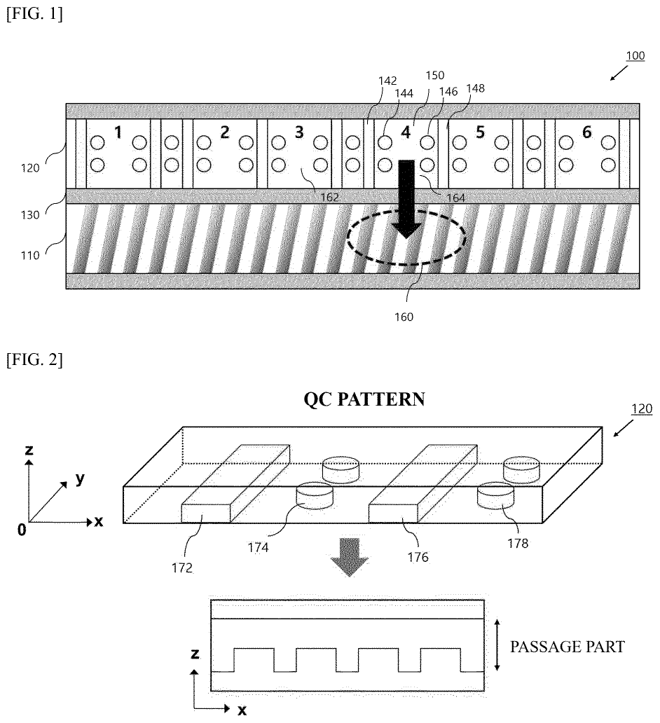

FIG. 1 is a diagram partially illustrating a target object separation device including a first passage part and a second passage part according to one embodiment of the present disclosure.

Referring to FIG. 1, the target object separation device 100 may include a first passage part 110 in which a fluid flows with being concentrated in a certain direction in the process that the fluid flows, a second passage part 120 formed separately from the first passage part 110 to check (confirm, determine) whether the first passage part 110 is formed at a constant height. In one embodiment, a blocking wall 130 may be interposed between the first passage part 110 and the second passage part 120. Accordingly, the first passage part 110 through which a fluid containing microparticles passes and the second passage part 120 through which a quality control (QC) solution passes may have independent passages without any inflow or interference therebetween. That is, only microfluid can flow in the first passage part 110, and only the QC solution can flow in the second passage part 120.

In one embodiment, the second passage part 120 may be divided into a plurality of zones. The height of each of the plurality of zones of the second passage part 120 may be used to identify the height of the corresponding zone of the first passage part 110.

In one embodiment, the first passage part 110 may include one or more first structures and the second passage part 120 may include one or more second structures 142, 144, 146, and 148. In addition, the second structure 142, 144, 146, 148 included in each of the plurality of zones of the second passage part 120 may be used to identify the height of micropattern (or the height of the first structure) in the corresponding zone of the first passage part 110. To this end, the first passage part 110 may have the same height as the second passage part 120, and the one or more second structures 142, 144, 146, and 148 may have the same height as the one or more first structures.

For example, the second passage part 120 may include a plurality of zones including a first zone 162 and a second zone 164. The second structures 144 and 146 disposed in the second zone 164 may have the same height as the first structure in the zone 160 of the first passage part 110 corresponding to the second zone 164. Additionally, the height of the second zone 164 may be the same as the height of the zone 160 of the first passage part 110 corresponding to the second zone 164. According to one embodiment, the height of the first zone and the height of the first structure may be identified based on the height of the second zone 164 and the height of the second structures 144 and 146 existing within the second zone 164.

According to one embodiment, the height of the second passage part 120 may be equal to the height of the first passage part 110 through which a microfluid flows, and thus the first passage part 110 through which the microfluid flows can be properly formed by the second passage part 120 formed separately from the first passage part 110. This can result in confirming whether a target object separation function can be smoothly performed.

In one embodiment, the second passage part 120 may further include an identifier structure 150. The identifier structure 150 may be a structure for identifying each of the plurality of zones of the second passage part. For example, the identifier structure 150 may be a structure in the form of numeral, which has the same height as the first structure. According to one embodiment, by disposing the identifier structure 150 in the second passage part 120, it can be indirectly identified where has been improperly formed in the first passage part 110.

FIG. 2 is a diagram illustrating a portion of a second passage part according to one embodiment of the present disclosure.

Referring to FIG. 2, the second passage part 120 may include one or more second structures 172, 174, 176, and 178. A pattern formed by the one or more second structures may be referred to as a quality control (QC) pattern. In one embodiment, the one or more second structures 172, 174, 176, and 178 may have the same height as the first structure of the first passage part 110, and cross-sections thereof may be formed in various shapes. For example, in an xy cross-section of FIG. 2, the second structure may have a circular, elliptical, rectangular, square, diamond shape, etc., having various sizes. For example, some (172 and 176) of the second structures may have the same height as the first structure and have a rectangular parallelepiped shape with the width of the second passage part 120. Some (174 and 178) of the second structures may have the same height as the first structure. That is, the second structures may have various shapes, such as a cylinder or a rectangular parallelepiped. Of course, all of the second structures may have the same shape. The one or more second structures 172, 174, 176, and 178 may be disposed in all or part of the second passage part 120.

In one embodiment, the QC pattern formed by the one or more second structures 172, 174, 176, and 178 may be formed to have the same height as the micropattern of the first passage part through which the microfluidic passes. Accordingly, the height of the QC pattern may correspond to the height of the micropattern of the first passage part.

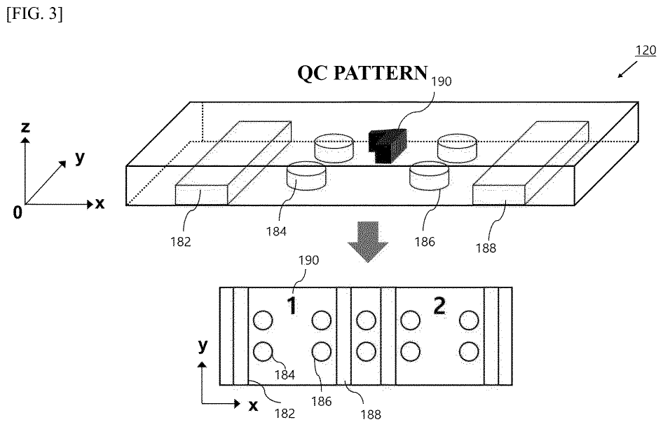

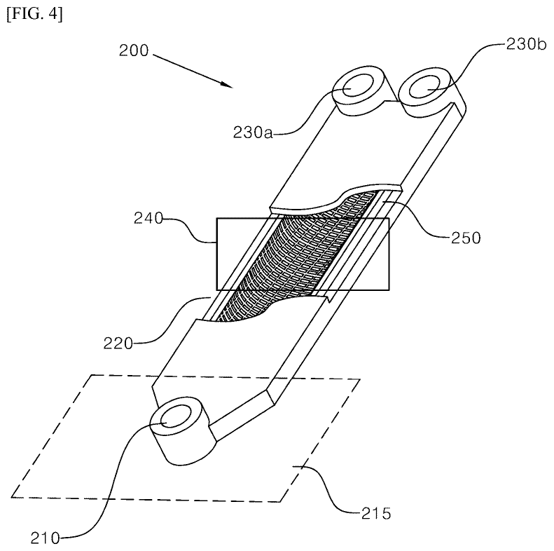

FIG. 3 is a diagram illustrating a portion of a second passage part including an identifier structure according to one embodiment of the present disclosure.

Referring to FIG. 3, the second passage part 120 may be divided into one or more zones. In one embodiment, the second passage part 120 may include one or more second structures 182, 184, 186, and 188 and an identifier structure 190. The identifier structure 190 may be a structure for identifying each of the one or more zones of the second passage part 120. Additionally, the identifier structure 190 may be formed at the same height as the one or more second structures 182, 184, 186, and 188. According to one embodiment, by disposing the identifier structure 190 in the second passage part 120, the zones can be identified during a QC process. At the same time, when a QC solution is injected into the second passage part 120, the QC solution can be filled from the height of the identifier structure up to the height of the second passage part 120, so that the identifier structure 190 itself can also be helpful in the QC process.

An xy cross-section of the second passage part 120 viewed from the top in the upper drawing of FIG. 3 is shown in the lower drawing. That is, a corresponding zone can be identified through the identifier structure 190. To facilitate identification, the identifier structure 190 may be made opaque.

In one embodiment, the second passage part 120 may be divided into n zones according to the length of the passage part (or a channel length). For example, when a channel length is long, the second passage part 120 may be divided into 200 zones, and the zones may include the identifier structures 190 numbered from 1 to 200, respectively. Alternatively, when the channel length is short, the second passage part 120 may be divided into 30 zones, and the zones may include the identifier structures 190 numbered from 1 to 30, respectively. The height of a zone may be identified based on the height of the identifier structure corresponding to the zone.

FIG. 4 is a diagram schematically illustrating the configuration of a target object separation device according to one embodiment of the present disclosure.

Referring to FIG. 4, a target object separation device 200 may include an injection port 210, an injection part 215, a first passage part 220, a second passage part (not illustrated), a target object acquisition part 230b, a non-target object discharge part 230a, a high-speed channel portion 250, etc. (here, the high-speed channel portion 250 may be optional). In one embodiment, a fluid containing microparticles may be injected into the target object separation device 200 through the injection port 210. The injection part 215 may refer to a fluid flow passage adjacent to the injection port 210. In one embodiment, as the injected fluid flows through the injection part 215 and the first passage part 220, a target object may be intensively separated in a certain direction. Additionally, the separated target object may be concentrated into the target object acquisition part 230b. Additionally, a non-target object other than the target object may be concentrated into the non-target object discharge part 230a.

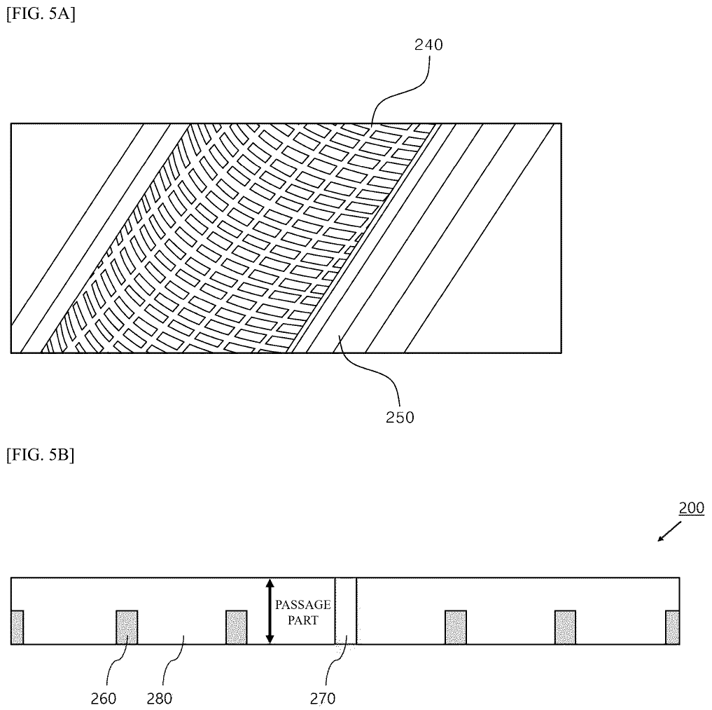

In one embodiment, at least one of the injection part 215, the first passage part 220, the target object acquisition part 230b, and the non-target object discharge part 230a may include at least one pillar structure. For example, a target object separation device for separating white blood cells may have the pillar structure in the injection part 215, a target object separation device for separating plasma may have the pillar structures in the injection part 215 and the first passage part 220, and a target object separation device for separating cells may have the pillar structures in all of the injection part 215, the first passage part 220, the target object acquisition part 230b, and the non-target object discharge part 230a. The pillar structure may also optionally be present in the second passage part of each of those devices. Additionally, each zone may include a plurality of pillar structures. However, this is merely illustrative and various number of pillar structures may be present in various zones of the target object separation device. The pillar structure according to one embodiment of the present disclosure can suppress channel deformation due to sagging of a central portion of the channel and also suppress damage to a target object or adverse effects on the flow. The pillar structure will be described in more detail later with reference to FIG. 5B.

Although the second passage part is not illustrated in FIG. 4, the second passage part for checking whether the first passage part 110 has been formed at a certain height, as described with reference to FIGS. 1 to 3, may be formed separately from the first passage part 220.

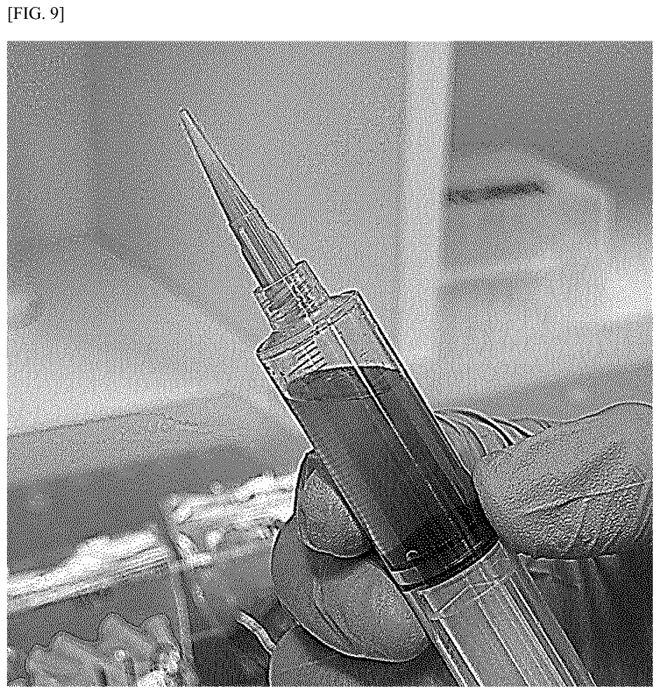

In one embodiment, a fluid containing microparticles may be injected into the injection port 210. For example, a fluid may be injected through a tube, syringe, pipette, etc. Preferably, the fluid may be injected through the syringe. A fluid injection will be described again with reference to FIG. 9. Additionally, for example, the fluid may contain whole blood for the purpose of obtaining leukocyte or plasma. Alternatively, the fluid may contain a cell culture fluid.

In one embodiment, while an injected fluid flows in the injection part 215 and the first passage part 220, the target object may be separated in a specific direction. Accordingly, the target object acquisition part 230b which is disposed on an end of the target object separation device 200 in a certain direction may acquire the separated target object. In addition, the non-target object discharge part 230a which is disposed on an end of a fluid passage of the target object separation device 200 may acquire the non-target object.

Alternatively, the target object acquisition part may be disposed on the end of the fluid passage of the target object separation device 200 and the non-target object discharge part may be disposed on the end of the target object separation device 200 in the certain direction (not illustrated). For example, the non-target object acquisition part may form a channel to be located in the middle of the fluid passage of the target object separation device 200. Additionally, the non-target object acquisition part may be provided in plurality.

In one embodiment, the target object of the target object separation device 200 may vary depending on the pattern of the first passage part 220 of the target object separation device 200.

In one embodiment of the present disclosure, an example in which one target object acquisition part 230b and one non-target object discharge part 230a are disposed is illustrated, but it is merely illustrative, and at least one of the target object acquisition part and the non-target object discharge part may be provided in plurality. For example, the target object separation device 200 may include two or more, for example, four to ten target object acquisition parts. Additionally, in another example, the target object separation device 200 may include three or more, for example, 4 to 30, more specifically, 8 to 15 non-target object discharge parts. The number of target object acquisition parts and the number of non-target object discharge parts may be determined to be the same as or different from each other depending on the target object.

In addition, the target object acquisition part 230b may also be referred to as a first target object acquisition part, and the non-target object discharge part 230a may also be referred to as a second target object acquisition part. Unless otherwise specified, the configuration regarding the number of target object acquisition parts 230b or non-target object discharge parts 230a may be equally applied to a target object acquisition part and a non-target object discharge part of a target object separation device according to each embodiment disclosed below.

In one embodiment, a plurality of channels may be formed in the target object separation device 200. A channel is a passage extending from the injection port to the target object acquisition part or the non-target object discharge part, and the number of channels may be determined equally or differently depending on a target object. The number of channels may be 1 to 40, specifically, 2 to 30, and more specifically, 5 to 20. For example, in terms of the number of channels from the injection port to the target object acquisition part, a leukocyte separation device may have 6 channels, a plasma separation device may have 6 channels, and a cell separation device may have 2 channels. However, these are merely illustrative, and the target object separation device 200 may be configured to have various numbers of channels.

In one embodiment, each channel starting from the injection port may branch into various channels in the middle of a passage extending toward the target object acquisition part or the non-target object discharge part, thereby generating additional channels. For example, a separate channel may be created in the middle of a channel and the non-target object discharge part may be disposed at the end of the channel. For example, if there are eight non-target object discharge ports, eight additional channels may be created from the channel(s) starting from the injection port.

In one embodiment, a micropattern may be formed in the first passage part 220. The micropattern may be formed by one or more first structures and a plurality of engraved structures. Each of the engraved structures may have a groove shape in a direction perpendicular to a main flow direction of a fluid, and the first structure may be formed in a relief shape between the plurality of engraved structures. In one embodiment, as a fluid injected into the target object separation device 200 through the injection port 210 flows along the injection part 215 and the first passage part 220, the target object may be intensively separated in a certain direction. The separation of the target object may be performed by the plurality of engraved structures disposed in a ceiling or bottom surface of the channel disposed within the first passage part 220. In one embodiment, the engraved structure may also be referred to as an engraved channel portion or a groove.

In one embodiment, the plurality of engraved structures may have a structure in which they are disconnected from one another. According to one embodiment, the engraved structure may induce a secondary flow in a direction perpendicular to the direction in which the fluid mainly flows, so that microparticles can be efficiently separated and concentrated.

In one embodiment, the engraved structure may be an inclined structure having a curved shape in a longitudinal direction. For example, the micropattern formed by the plurality of engraved structures may have a curved shape. For example, the curve may include at least a portion of a circle, at least a portion of an ellipse, at least a portion of a cycloid, an arbitrary curved shape, etc.

In one embodiment, the micropattern of the target object separation device 200 may be formed at an angle ranging from 45 to 135 degrees based on the main flow direction of the fluid. For example, when the main flow direction of the fluid is set to an x-axis, the angle θ of the micropattern may range from about 45 degrees to about 135 degrees. At this time, the angle θ of the micropattern may be determined depending on what the target object is. For example, depending on the target object, the angle θ of the micropattern in one channel in the target object separation device may be about 45 degrees, and the angle θ of the micropattern in another channel may be about 135 degrees. In another example, the angle θ of the micropattern in one channel may be about 60 degrees and the micropattern in another channel may be about 120 degrees. In still another example, the angle θ of the micropattern in one channel may be about 75 degrees and the micropattern in another channel may be about 105 degrees. However, there are merely illustrative and the angle θ of the micropattern may be appropriately selected depending on the target object.

In one embodiment, a high-speed channel portion 250 may be formed in at least a portion of an area between the injection port 210 and the target object acquisition part. Additionally, an engraved structure (or a first structure) may not be disposed in the high-speed channel portion 250, and a plurality of engraved structures (or first structures) may be disposed only in areas other than the high-speed channel portion 250. The high-speed channel portion 250 will be described in more detail later with reference to FIG. 5.

In FIG. 4, the target object acquisition part or non-target object discharge part is disposed at the end of the target object separation device, but is merely illustrative. Of course, at least one of the target object acquisition part and the non-target object discharge part may be located in the middle portion of the target object separation device. For example, if the target object separation device is a plasma separation device, a plasma acquisition part for acquiring the plasm as a target object may be located in the end of the plasma separation device, and an erythrocyte or leukocyte discharge port for discharging the erythrocyte or leukocyte as a non-target object may be located in the middle of the separation device. Similarly, when the target object separation device is a leukocyte separation device, a leukocyte acquisition part for acquiring the leukocyte as a target object may be located in the end of the separation device, and an erythrocyte discharge port for discharging the erythrocyte as a non-target object may be located in the middle part of the separation device.

FIG. 5A is an enlarged view of a portion of the target object separation device of FIG. 4.

Referring to FIG. 5A, an enlarged view of a portion of the first passage part 220 of FIG. 4 is shown. In one embodiment, the passage part may include a plurality of engraved structures and a high-speed channel portion 250. In one embodiment, the plurality of engraved structures may have a curved shape in the longitudinal direction, and a curved micropattern may be formed by these engraved structures (and the first structures in the relief form). For example, the micropattern formed by the plurality of engraved structures may have an arcuate shape. Additionally, for example, the curve may include at least a portion of a circle, at least a portion of an ellipse, at least a portion of a cycloid, an arbitrary curved shape, etc.

In one embodiment, no engraved structure may be disposed in the high-speed channel portion 250, and a plurality of engraved structures may be disposed only in the passage part except for the high-speed channel portion 250. According to one embodiment, the high-speed channel portion 250 may be a ditch-shaped channel formed along a depth direction in a direction that microparticles are concentrated. As such a ditch-shaped channel is formed, concentration efficiency of the target object can increase and loss in an opposite direction can decrease. In other words, the high-speed channel portion 250 can serve as a structure for trapping microparticles.

In one embodiment, the high-speed channel portion 250 may be formed in at least a portion of an area from the injection part to the target object acquisition part. According to one embodiment, the existence of the high-speed channel portion 250 may reduce fluid resistance and increase local flow velocity. In addition, this can reduce pressure and thus generate a flow in a direction toward the high-speed channel portion 250, thereby increasing the concentration efficiency of the target object.

FIG. 5B is a schematic cross-sectional view of a target object separation device including a pillar structure according to one embodiment of the present disclosure.

Referring to FIG. 5B, in order to suppress sagging of the center portion of a channel, a pillar structure 270 may be installed in the target object separation device 200. In one embodiment, the pillar structure 270 may be disposed in at least one of the injection part, the first passage part, the second passage part, the target object acquisition part, and the non-target object discharge part, and may be provided in plurality. For example, in the target object separation device 200 for separating leukocyte, the pillar structure 270 may be disposed only in the injection part. Additionally, for example, in the target object separation device 200 for separating plasma, the pillar structures 270 may be disposed in the injection part and the first passage part. In addition, for example, in the target object separation device 200 for separating cells, the pillar structures 270 may be disposed in all of the injection part, the first passage part, and the target object acquisition part. The pillar structure may also optionally be present in the second passage part of each of those devices. For example, the pillar structures 270 may be disposed in the center of a channel, may be disposed at appropriate intervals, may be disposed between engraved structures, or may be disposed at appropriate intervals in the center of the channel.

In one embodiment, the pillar structure 270 may be disposed in an area except for the plurality of engraved structures 280. For example, the pillar structure 270 may be disposed between at least some of the structures 260 (e.g., the first structures or the second structures) forming the engraved structure 280. In one embodiment, the pillar structure 270 should be disposed in a way that hemolysis does not occur and an affection to a flow is not caused. Accordingly, the pillar structure 270 may have the same height as the passage part, but a cross-section thereof cut on an xy plane when the main flow direction of the fluid is an x-axis and a width direction of a channel is a y-axis may be in a shape of a circle, ellipse, streamline (e.g., a ship-like shape), round polygon, etc. When the cross-section is polygonal, a cross-sectional area at each vertex is small, so when a target object such as a cell or a non-target object hits the vertex, a great impact may be applied to the target object or non-target object, causing damage to the target object or non-target object. Therefore, when the pillar structure 270 has a polygonal shape with vertices, the cross-section of the pillar structure 270 may have a rounded polygonal shape in which each vertex portion is rounded.

In one embodiment, the height of the pillar structure 270 may be the same as the height of the passage part. Accordingly, the pillar structure 270 may have a shape of a cylinder, an elliptical pillar, a streamlined pillar, or a rounded polygonal pillar.

In one embodiment, in the case where the pillar structure 270 is provided in plurality, in order to suppress damages to microparticles, a gap between the plurality of pillar structures must be wider than a diameter of the microparticle. This is to suppress damages to the microparticles, such as entrapment of microparticles and hemolysis by the pillar structures.

In one embodiment, the pillar structure 270 may be made of plastic. In this case, the aspect ratio (height/length of cross-section; i.e., height of passage part/maximum length of cross-section) of the pillar structure 270 must be equal to or less than a certain value. For example, when the target object separation device 200 is manufactured using a quick delivery mold (QDM) method, if the aspect ratio of the pillar structure 270 exceeds 3, the pillar structure may be damaged during the manufacturing process. Accordingly, the maximum length of the cross-section of the pillar structure may be determined depending on the height of the passage part. For example, if the height of the passage part is about 40 μm, the maximum length of the cross-section of the pillar structure should be about 13 μm or more.

In one embodiment, at least one pillar structure 270 may be disposed within a point which is approximately 50% of a channel width from both ends of the channel, to suppress sagging in the center portion of the channel. For example, the pillar structures 270 may be disposed in the center of a channel, or may be disposed at points that are about ⅓, that is, about 33% of the channel width from both ends of the channel.

In one embodiment, in order to suppress an affection to the flow of microparticles, when there are a plurality of pillar structures 270, a gap between the pillar structures 270 must be equal to or wider than the length of the engraved structure 280. According to the separation principle of the target object separation device, when a sample is injected into the target object separation device, a secondary flow (defocusing flow) may be formed along an inclined direction of the engraved structure 280, and a flow in an opposite direction (focusing flow) may be formed in the passage part. At this time, the focusing flow may cause the microparticles to be biased toward one sidewall, causing the microparticles to be separated. In this process, when the pillar structures 270 exist at a gap, which is shorter than the length of the engraved structure 280, the defocusing flow toward the engraved structure may be interrupted by the pillar structure 270, thereby causing the focusing flow to be weakened. This may affect the separation efficiency of the target object separation device 200. Accordingly, the gap between the pillar structures 270 may be formed to be wider than the length of the engraved structure 280 so as not to interfere with the secondary flow.

According to one embodiment, the use of the pillar structures 270 can result in suppressing the target object separation device from sagging in the center of the channel.

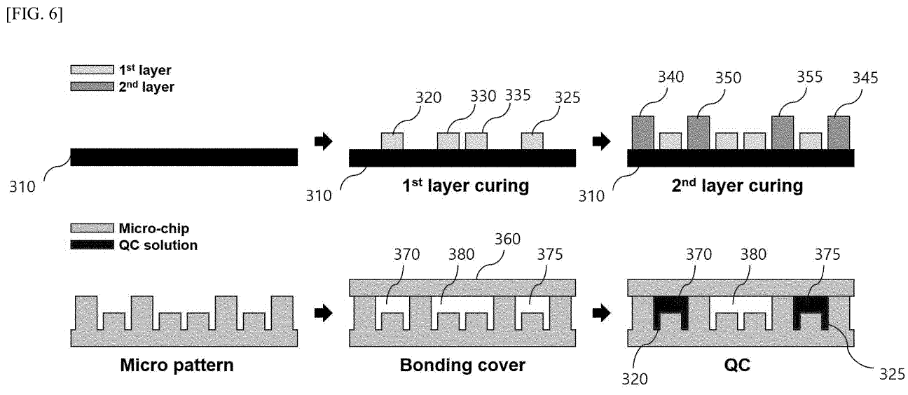

FIG. 6 is a diagram illustrating a method for manufacturing a target object separation device according to one embodiment of the present disclosure.

Referring to FIG. 6, a method for manufacturing a target object separation device may include preparing a base substrate 310 and curing a first layer for forming one or more first structures 330 and 335 and one or more second structures 320 and 325 on the base substrate 310. In one embodiment, the first structures 330 and 335 may be structures formed in a first passage part 380 in which a target object flows with being concentrated in a certain direction while a fluid injected into an injection part flows, and the second structures 320 and 325 may be structures formed in second passage parts 370 and 375 that are formed separately from the first passage part in order to confirm whether the first passage part is formed at a constant height. In addition, the first structures 330 and 335 and the second structures 320 and 325 may be formed at the same height. In one embodiment, the second structures 320 and 325 may be disposed in all or part of the second passage parts 370 and 375 repeatedly in a certain pattern or in a plurality of deformed patterns.

In one embodiment, the method for manufacturing the target object separation device may include curing a second layer for forming pillars 340 and 345 and blocking walls 350 and 355 of the target object separation device on the base substrate 310. In one embodiment, the pillars 340 and 345 and the blocking walls 350 and 355 may be formed at the same height. The blocking walls 350 and 355 may be walls between the first passage part 380 and the second passage parts 370 and 375, and allow the first passage part 380 and the second passage parts 370 and 375 to have independent passages of each other, such that passing, inflow, interference and the like of a fluid therebetween can be suppressed.

In one embodiment, the method for manufacturing the target object separation device may include coupling a cover to the top of the pillars and the blocking walls which have been made through the aforementioned process. The first passage part 380 and the second passage parts 370 and 375 may be formed by coupling the cover. In one embodiment, the first passage part 380 and the second passage part 370, 375 may be one or plural.

In one embodiment, a QC process may be carried out by filling a QC solution in the second passage parts 370 and 375. Additionally, by irradiating light to the QC solution, the height of the second passage parts 370 and 375 and the height of the second structures 320 and 325 may be identified. In one embodiment, the irradiation of light to the QC solution may be performed through LED or visible light.

In one embodiment, since the second passage parts 370 and 375 is manufactured to have the same height as the height of the first passage part 370, the height of the first passage part 370 can be indirectly obtained from the height of the second passage parts 370 and 375 identified through the QC solution. Likewise, since the second structures 320 and 325 are manufactured to have the same height as the height of the first structures 330 and 335, the height of the first structures may be indirectly obtained from the height of the second structures 320 and 325 identified through the QC solution.

According to one embodiment, it can be confirmed through the second passage parts 370 and 375 whether the first passage part through which the fluid containing microparticles passes has been manufactured at a certain height. Here, the certain height may not refer to a specific value but may be a concept that includes a height within a specific range.

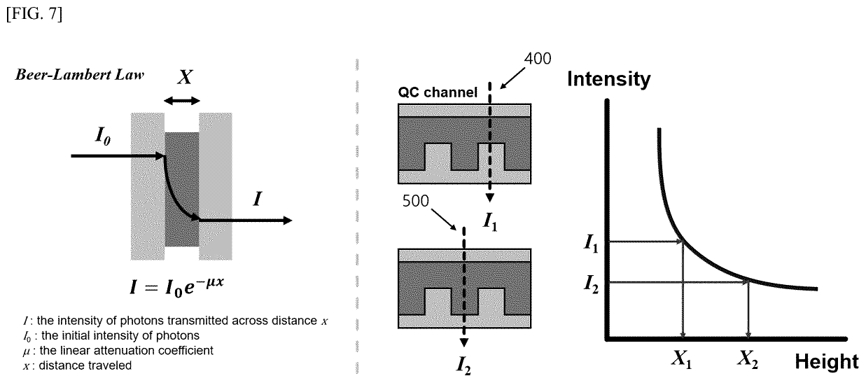

FIG. 7 is a diagram illustrating a method (QC method) for confirming the height of a passage part according to one embodiment of the present disclosure.

In one embodiment, the QC of the target object separation device is detected based on a color change according to a height difference of a passage part. In other words, a dark color appears in a passage with a high height and a light color appears in a passage with a low height. These are detected by an optical sensor to calculate a height from a color change (change in absorbance). For this purpose, a reference curve must first be drawn up. This involves taking images of the same dye solution at each height and analyzing the degree of darkness using software, and creating a reference curve where an x-axis is a height and a y-axis is absorbance.

Referring to FIG. 7, a method for identifying the height of the second passage part (QC channel) and the height of the second structure by irradiating light to the QC solution is illustrated. In the description referring to FIG. 7, the Beer-Lambert Law is used, but it is not limited thereto, and various methods for identifying the height of the second passage and the second structure may be used.

In one embodiment, according to the Beer-Lambert law, the intensity of light passing through a material may be expressed as in the following [Equation 1].

$$I = {I}_{0} {e}^{- μ x} \qquad [ Equation 1 ]$$

where I may denote the dose or intensity of light (or photon) after the light has passed through a QC solution by a thickness x, I₀ may denote the initial dose or intensity of light (or photon), μ may denote a linear attenuation coefficient, and x may denote a thickness of the QC solution. The height of at least one of the second passage part and the second structure can be identified by using [Equation 1] and the previously-drawn height-absorbance reference curve.

For example, after filling the QC solution in the second passage and taking an image of the QC solution, the intensity of light may be measured through dedicated software. When the intensity of light after passing through the second passage part at a first point 400 is I₁, it can be identified through the reference curve that the height corresponding to I₁ is X₁. Accordingly, it can be seen that a height obtained by subtracting the height of the second structure from the height of the second passage part is X₁, and furthermore, this height is recognized as a height obtained by subtracting the height of the first structure from the height of the first passage part. In addition, when the intensity of light after passing through the second passage part at a second point 500 is I₂, it can be identified through the reference curve that a height corresponding to I₂ is X₂. Accordingly, it can be seen that the height of the second passage part is X₂, and this height is indirectly recognized as the height of the first passage part. Additionally, the height of the second structure may be identified as X₂−X₁, and this height may be indirectly recognized as the height of the first structure. In one embodiment, if at least one of the height of the second passage part and the height of the second structure is outside the reference range, the corresponding target object separation device may be determined to be defective and may not be used.

Referring to FIG. 7, the method of performing the QC process using the Beer-Lambert Law is illustrated, but the present disclosure is not limited thereto. The QC process may alternatively be performed by using various methods capable of measuring the height of the QC solution. For example, after filling the QC solution, images of various areas of the second passage part may be acquired, and the images of the various areas may be analyzed using dedicated software to identify heights of the various areas of the second passage part through brightness of colors.

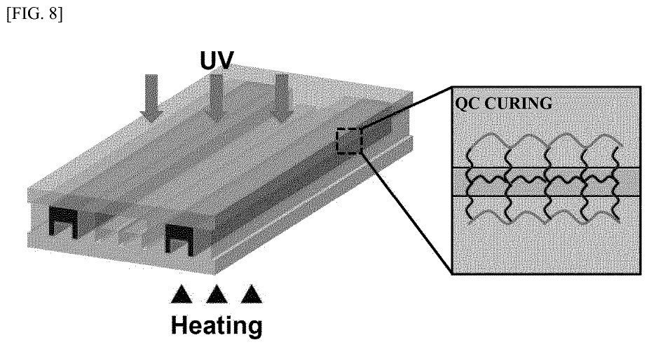

FIG. 8 is a diagram illustrating a process of curing a QC solution according to one embodiment of the present disclosure.

Referring to FIG. 8, a QC solution to be used may be filled in the second passage part and cured after completing a QC process, thereby improving bonding strength of the target object separation device. For this purpose, the QC solution may contain one or more host materials that have one or more vinyl groups and are in a liquid state. In addition, the QC solution may further contain an initiator soluble in the host material, a dye soluble in the host material, etc.

Accordingly, the present disclosure also provides a QC solution that contains the host material, which has the one or more vinyl groups and are in the liquid state, the initiator, and the dye.

In one embodiment, the host material may consist of, but is not limited to, any one or more of the following: 2-Hydroxyethyl methacrylate, 2-hydroxyethyl acrylate, styrene, poly(2-hydroxyethyl methacrylate), ethylene glycol dimethacrylate, ethylene glycol diacrylate, methyl methacrylate, butyl methacrylate, di(ethylene glycol) diacrylate, tri (ethylene glycol) diacrylate, tetra(ethylene glycol) diacrylate, di(ethylene glycol) dimethacrylate, tri (ethylene glycol) dimethacrylate, tetra(ethylene glycol) dimethacrylate, poly(ethylene glycol) diacrylate (product group with Mn of 700 or less, e.g., 250, 575, 700), 1,4-butanediol diacrylate, 1,3-butanediol diacrylate, 1,4-butanediol dimethacrylate, 1,6-hexanediol dimethacrylate, 1,6-hexanediol diacrylate, diurethane dimethacrylate, bisphenol A ethoxylate dimethacrylate, bisphenol A glycerolate dimethacrylate, bisphenol A glycerolate diacrylate, tri (propylene glycol) diacrylate, poly(propylene glycol) diacrylate, methyl acrylate, ethyl acrylate, propyl acrylate, butyl acrylate, pentyl arylate, hexyl acrylate, heptyl acrylate, octyl acrylate, benzyl acrylate, tert-butyl acrylate, isodecyl acrylate, acrylic acid, methyl 2-(hydroxy methyl) acrylate, 2-ethylhexyl acrylate, 2-carboxyethyl acrylate, poly(ethylene glycol) methyl ether acrylate, ethylene glycol methyl ether acrylate, ethylene glycol phenyl ether acrylate, 2-(dimethylamino)ethyl acrylate, 4-hydroxybutyl acrylate, hydroxypropyl acrylate, trimethylsilyl acrylate, 2-chloroethyl acrylate, ethyl 2-(hydroxymethyl) acrylate, 3-(dimethylamino) propyl acrylate, 2-tetrahydropyranyl acrylate, methyl 2-(chloromethyl) acrylate, 2-(diethylamino)ethyl acrylate, vinyl chloride, 3,5,5-trimethylhexyl acrylate, ethyl 2-(bromomethyl) acrylate, acrylic anhydride, 3-(trimethoxysilyl) propyl acrylate, glycerol dimethacrylate, and 4-hydroxybutyl acrylate.

In one embodiment, the initiator may consist of, but is not limited to, any one or more of the following: azobisisobutyronitrile, benzoyl peroxide, 2-hydroxy-4′-(2-hydroxyethoxy)-2-methylpropiophenone, 2-methyl-4′-(methylthio)-2-morpholinopropiophenone, 2-hydroxy-2-methylpropiophenone, 2,2′-azobis(2-methylbutyronitrile), 2,2′-azobis(2,4-dimethylvaleronitrile), 4,4′-azobis(4-cyanovaleric acid), dimethyl 2,2′-azobis(2-methylpropionate), 2,2′-azobis(2-methylpropionamidine) dihydrochloride, tert-butylhydroperoxide, cumene hydroperoxide, di-tert-butylperoxide, dicumylperoxide, camphorquinone, acetophenone, 3-acetophenol, 4-acetophenol, benzophenone, 2-methylbenzophenone, 3-methylbenzophenone, 3-hydroxybenzophenone, 3,4-dimethylbenzophenone, 4-hydroxybenzophenone, 4-benzoylbenzoic acid, 2-benzoylbenzoic acid, methyl 2-benzoylbenzoate, 4,4′-dihydroxybenzophenone, 4-(dimethylamino)-benzophenone, 4,4′-bis(dimethylamino)-benzophenone, 4,4′-bis(diethylamino)-benzophenone, 4,4′-dichlorobenzophenone, 4-(p-tolylthio)benzophenone, 4-phenylbenzophenone, 1,4-dibenzoylbenzene, benzyl, 4,4′-dimethylbenzyl, p-anisyl, 2-benzoyl-2-propanol, 1-benzoylcyclohexanol, benzoin, anisoin, benzoinmethylether, benzoinethylether, benzoinisopropylether, benzoinisobutylether, O-tosylbenzoin, 2,2-diethoxyacetophenone, benzyl dimethyl ketal, 2-benzyl-2-(dimethylamino)-4′-morpholinobutyrophenone, 2-isonitrosopropiophenone, anthraquinone, 2-ethylanthraquinone, sodium anthraquinone-2-sulfonate monohydrate, 9,10-phenanthrenequinone, dibenzosuberenone, 2-chlorothioxanthone, 2-isopropylthioxanthone, 2,4-diethylthioxanthen-9-one, 2,2′-bis(2-chlorophenyl)-4,4′,5,5′-tetraphenyl-1,2′-biimidazole, diphenyl(2,4,6-trimethylbenzoyl) phosphineoxide, phenylbis(2,4,6-trimethylbenzoyl) phosphineoxide, and Lithium phenyl(2,4,6-trimethylbenzoyl) phosphinate

In one embodiment, the dye may consist of, but is not limited to, any one or more of the following: Oil red O, Oil red EGN, Sudan red B, Sudan I, Sudan II, Sudan III, Sudan IV, Sudan red 7B, Sudan red G, Sudan red B, Sudan black B, Sudan I-d5, Sudan IV-d6, 4-aminoazobenzene, fast garnet GBC Base, quinaldine red, phenol red, pyrogallol red, cresol red, methyl red, Congo Red, neutral red, direct red 80, nile red, chlorophenol red, acid red 1, disperse Red 19, mito red, para red, direct red 23, disperse red 13, disperse red 1, acid red 33, direct red 81, allura red AC, pigment red 53, citrus red 2, acid red 73, disperse red 17, methyl orange, reactive orange 16, acridine orange base, orange G, thiazole orange, disperse orange 3, Sudan orange G, disperse orange 1, pigment orange 5, quinoline yellow, brilliant yellow, metanil yellow, butter yellow, acid yellow 25, nitrazine yellow, acridine yellow G, titan yellow, disperse yellow 3, solvent yellow 124, methyl green, indocyanine green, solvent green 3, janus green B, leucomalachite green, malachite green chloride, naphthol green B, thymol blue, xylenol blue, celestine blue, bromothymol blue, nile blue A, trypan blue, toluidine blue, acid blue 129, oil blue N, Sudan blue II, Sudan blue 59, indigo blue, eriochrome blue-black B, ethyl violet, pyrocatechol violet, crystal violet, methyl violet, leucocrystal violet, methylene violet, Sudan Black B, naphthol blue black, and solvent black 28.

For example, the QC solution may contain a host material of poly(ethylene glycol) diacrylate (PEGDA575), an initiator of azobisisobutyronitrile (AIBN), and a dye of oil red O. Accordingly, one embodiment of the present disclosure provides a QC solution containing: poly(ethylene glycol) diacrylate (PEGDA575); azobisisobutyronitrile; and oil red O dye. In a more specific embodiment, the QC solution may contain 98.6% by weight of PEGDA575, 1% by weight of AIBN initiator, and 0.4% by weight of Oil red O dye, based on a total weight.

FIG. 9 is a diagram illustrating a plastic syringe tip for extracting a fluid without a generation of microbubbles according to embodiment of the present disclosure.

Referring to FIG. 9, a syringe may be provided with a syringe tip to inject a fluid into the injection port 210 without generating microbubbles. Commonly used needles, for example, stainless steel needles, form numerous microbubbles if pressure formed inside the syringe is not precisely controlled during fluid extraction. These microbubbles reduce the performance of the target object separation device, such as impeding the flow direction of the fluid. Unlike these syringe needles, the syringe tip according to the present disclosure may have a conical shape with a gradually increasing diameter. Accordingly, pressure generated inside the syringe can be kept constant during fluid extraction, and thus microbubbles cannot be generated inside the syringe.

In one embodiment, a syringe may be formed integrally with a syringe tip. In one embodiment, the syringe tip may be made of a plastic material, such as polypropylene (PP) or polyethylene (PE), without limitation. In another embodiment, a plastic syringe tip may be attached to or detached from the syringe in a rotating manner. In one embodiment, the syringe tip may have a diameter of 8G to 30G, for example, 8G, 10G, 11G, 14G, 16G, 18G, 20G, etc. Preferably, the syringe tip may not generate microbubbles regardless of its diameter.

The foregoing description of the present disclosure is for illustrative purposes only, and it will be understood by those of ordinary skill in the art that the present disclosure can be easily modified into other specific forms without changing technical idea or essential features of the present disclosure. Therefore, the embodiments described above should be understood in all aspects as illustrative and not limited. For example, each component described as a singular form may be implemented in a distributed manner, and similarly, components described as being distributed may also be implemented in a combined form.

The scope of the present disclosure is determined by the claims to be described below rather than the detailed description above. All changes or modifications derived from the meaning and scope of the claims and their equivalent concepts should be construed as being included in the scope of the present disclosure.

What is claimed is:

1. A target object separation device comprising:
an injection part into which a fluid containing microparticles is injected;
a first passage part that includes one or more first structures and in which a target object flows with being concentrated in a certain direction while the fluid injected into the injection part flows;
a second passage part that is separately formed from the first passage part; and
a target object acquisition part that acquires the target object concentrated in the certain direction,
wherein the second passage part is a passage part in which a quality control (QC) solution is filled, has the same height as the first passage part, and comprises one or more second structures formed at the same height as each of the one or more first structures.

2. The target object separation device of claim 1, wherein the second passage part comprises a first zone and a second zone,
the second structure disposed in the first zone has the same height as the first structure disposed in a zone on the first passage part corresponding to the first zone, and
the second structure disposed in the second zone has the same height as the first structure disposed in a zone on the first passage part corresponding to the second zone.

3. The target object separation device of claim 1, wherein the second passage part comprises a plurality of zones,
identifier structures for the plurality of zones are disposed in the plurality of zones, respectively, and
the second structure and the identifier structure disposed in each of the plurality of zones have the same height as the first structure located on a zone of the first passage part corresponding to each of the plurality of zones.

4. The target object separation device of claim 1, wherein a blocking wall is formed between the first passage part and the second passage part.

5. The target object separation device of claim 1, wherein the QC solution is cured after being filled in the second passage part to improve bonding strength of the target object separation device.

6. The target object separation device of claim 5, wherein the QC solution contains a host material, which has one or more vinyl groups and is in a liquid state, an initiator soluble in the host material, and a dye soluble in the host material.

7. A method for manufacturing a target object separation device, the method comprising:
forming one or more first structures and one or more second structures on a base substrate;
forming a pillar and a blocking wall of the target object separation device on the base substrate; and
coupling a cover to top of the pillar and the blocking wall,
wherein the blocking wall is a wall between a first passage part and a second passage part,
the first passage part is a passage part in which a target object flows with being concentrated in a certain direction while a fluid injected into an injection part flows,
the second passage part is a passage part in which a quality control (QC) solution is filled and which is formed separately from the first passage part, and
each of the one or more first structures has the same height as the corresponding second structure.

8. The method of claim 7, wherein the second passage part comprises a first zone and a second zone,
the second structure disposed in the first zone has the same height as the first structure disposed in a zone on the first passage part corresponding to the first zone, and
the second structure disposed in the second zone has the same height as the first structure disposed in a zone on the first passage part corresponding to the second zone.

9. The method of claim 7, wherein the second passage part comprises a plurality of zones, and
the method for manufacturing the target object separation device further comprises forming identifier structures for the plurality of zones in the plurality of zones, respectively, and
the second structure and the identifier structure disposed in each of the plurality of zones have the same height as the first structure located on a zone of the first passage part corresponding to each of the plurality of zones.

10. The method of claim 7, wherein the QC solution is cured after being filled in the second passage part to improve bonding strength of the target object separation device.

11. The method of claim 10, wherein the QC solution contains a host material, which has one or more vinyl groups and is in a liquid state, an initiator soluble in the host material, and a dye soluble in the host material.

12. A quality control (QC) method of a target object separation device, the QC method comprising:
injecting a QC solution into a second passage part of the target object separation device;
identifying a height of the QC solution in the second passage part; and
identifying that the target object separation device is defective when the height of the QC solution does not meet a predetermined range reference,
wherein the target object separation device comprises an injection part into which a fluid containing microparticles is injected, a first passage part in which a target object flows with being concentrated in a certain direction while the fluid injected into the injection part flows, a second passage part that is separately formed from the first passage part, and a target object acquisition part that acquires the target object concentrated in the certain direction.

13. The QC method of claim 12, further comprising curing the QC solution injected into the second passage part,
wherein the first passage part comprises one or more first structures, and
the second passage part has the same height as the first passage part and comprises one or more second structures formed at the same height as each of the one or more first structures.

14. The QC method of claim 13, wherein the identifying the height of the QC solution in the second passage part comprises identifying at least one of a height of the second passage part, a height of the second structure, and a height difference between the second passage part and the second structure, and
the identifying that the target object separation device is defective comprises identifying that the target object separation device is defective when at least one of the height of the second passage part, the height of the second structure, and the height difference between the second passage part and the second structure does not meet a predetermined range reference.

15. The QC method of claim 12, wherein the identifying the height of the QC solution in the second passage part comprises identifying the height of the QC solution by irradiating light to the QC solution.
